(19) United States
(12) Patent Application Publication
(10) Pub. No.: US 2026/0208376 A1
(43) Pub. Date: Jul. 23, 2026

(54) SCISSORS

(71) Applicant: Jeong Pyo KIM, Seoul (KR)

(72) Inventor: Jeong Pyo KIM, Seoul (KR)

(21) Appl. No.: 18/876,896

(22) PCT Filed: Jun. 16, 2023
(86) PCT No.: PCT/KR2023/008399

§ 371 Date: Dec. 19, 2024

(30) Foreign Application Priority Data
Jun. 24, 2022 (KR) 10-2022-0077463

(51) Int. Cl. B26B 13/06; B26B 13/28

(52) U.S. Cl. CPC B26B 13/06; B26B 13/28

(57) ABSTRACT

Provided are scissors comprising: a first cutting portion having an inner blade bent so as to be convex upwards while having a predetermined radius, and a first support rack formed to extend from one end of the inner blade, thereby supporting the inner blade; a second cutting portion having an outer blade provided in a bent shape so as to be convex upwards while having a predetermined radius, and disposed so as to surround the inner blade, and a second support rack formed to extend from both ends of the outer blade, thereby supporting the outer blade; a body portion comprising a pair of frames having a coupling groove provided on one side thereof such that one of the first and second support racks is fitted/coupled thereto, and having a holding portion provided on the other side thereof, and the body portion comprising a coupling portion for hinge-coupling the pair of frames such that the first and second cutting portions rotate around a point within a predetermined radius, thereby contacting or moving away from each other; and an elastic support portion positioned in the coupling groove so as to support at least one of the first and second support racks fitted/coupled to the coupling groove, thereby providing elastic restorative power to longitudinal movements of the first or second cutting portion.

### TECHNICAL FIELD

The present invention relates to scissors, and more specifically, to scissors for removing nose hair, which can safely and effectively cut the nose hair.

### BACKGROUND ART

In general, people have used scissors of a relatively small size, which can be put into the nose as a tool for trimming the nose hair, and as a result, there is a problem in use in that the user is injured on a cutting edge of the scissors. In particular, since a cutting blade portion makes direct contact with the inside of the nose, the cutting blade portion needs to be provided so that cutting is possible while not causing harm to the human body.

As a technology to solve the above problem, an electric nose hair razer or circular scissors in which front ends of blades of the scissors are provided in a circular shape has been proposed.

First, in the case of an electric nose hair razor such as the technology disclosed in Korean Unexamined Patent Publication No. 10-2007-0016994, cough and runny nose may be caused by unique vibration generated in a motor driven to rotate a blade provided for nose hair cutting, and when runny nose or nose hair continuously flows in the device, a sanitary problem due to bacterial reproduction may be accompanied.

Next, in the case of circular scissors such as the technology presented in Korean Registered Utility Model Publication No. 20-0255136, since only a tip portion is manufactured in a circular shape, the problem of causing injury to the inside of the nose has not been solved, and there is a limit to uniformly and conveniently trimming nose hair. It took a lot of time to cut the nose hair with careful attention because a small amount of the nose hair needs to be trimmed while observing his/her nostrils with a mirror. In addition, there is an inconvenience in having to turn the scissors vertically to efficiently cut the nose hair.

To solve the above problems, the present applicant has filed Korean Registered Patent Publication 10-1149836, “Scissors”.

The present application suggests scissors having a circular scissor blade capable of performing safe and effective cutting, but there are problems such as a reduction in lifespan and a decrease in cutting force due to a coupling structure of an inner blade and an outer blade of the circular scissor blade.

Referring to FIGS. 1a and 1b in more detail, the outer radius of the inner blade of the circular scissor blade has a structure that is appropriately larger than the inner radius of the outer blade and smaller than the outer radius, and this structure does not smoothly cut when the outer blade and the inner blade cut an object by a shearing force, and one side of two blades described above may overlap each other. That is, as the radii of the outer blade and the inner blade of the circular scissor blade overlap each other, one side of two blades may make contact with each other when cutting the object, so that an impact may be applied, and in order to cut the object, an additional force of pressing two blades needs to be applied such that the inner blade and the cutting portion of the outer blade make contact with each other. As a result, the scissor blades may be polished and damaged, which may act as a factor reducing the cutting force and the service life.

In addition, the inner blade and the outer blade are manufactured to be parallel to each other, and after the object is cut, the inner blade is inserted into the outer blade, and two blades are maintained in a fitted state without a gap. In this case, when the secondary cutting operation is performed after the primary cutting operation, an excessive force has to be applied to separate two stiff blades due to press-fit between the inner blade and the outer blade, which may cause inconvenience in use.

### DISCLOSURE

### Technical Problem

An object of the present invention is to provide scissors capable of safely and effectively cutting an object and maintaining a predetermined level of a cutting force for a long period of time.

### Technical Solution

To achieve the above object, scissors according to one embodiment of the present invention may include: a first cutting portion having an inner blade that has a predetermined radius and is bent convexly upward, and a first support rack that extends from one end of the inner blade to support the inner blade; a second cutting portion having an outer blade that has a predetermined radius and is provided in a bent shape so as to be convex upward, and is disposed so as to surround the inner blade, and second support racks that extend from both ends of the outer blade to support the outer blade; a body portion including a pair of frames formed at one side thereof with coupling grooves into which any one of the first and second support racks is fitted, and formed at the other side thereof with gripping portions, and a coupling portion for hinge-coupling the pair of frames such that the first and second cutting portions make contact with each other or are separated from each other while rotating around a point within a predetermined radius; and an elastic support portion positioned in the coupling groove so as to support at least one of the first and second support racks fitted into the coupling grooves, and configured to provide an elastic restoring force to a longitudinal movement of the first or second cutting portion.

In this case, the first support rack, the second support rack, and the coupling grooves may have coupling holes into which the coupling portion is coupled, and a length from one end of the coupling hole formed in the first support rack to a lower end of the first support rack coupled to the coupling groove may be shorter than a length from one end of the coupling hole formed in the second support rack to a lower end of the second support rack coupled to the coupling groove.

In addition, the elastic support portion may be positioned in an empty space that is defined by the lower end of the first support rack and both side surfaces and a lower surface of the coupling groove as a lower portion of the first support rack is fitted into the coupling groove such that the coupling hole formed in the first support rack is disposed on the same horizontal line as the coupling hole formed in the coupling groove.

In addition, the inner blade may be formed in an arc shape and bent convexly upward, in which a first inner blade arc, which is positioned, on a basis of a highest point, between one end making contact with the first support rack and the highest point, may have a radius different from a second inner blade arc positioned between the highest point and the other end.

In this case, a radius corresponding to an outer circumferential surface of the second inner blade arc may be larger than a radius corresponding to an inner circumferential surface of an outer blade arc, and may be smaller than a radius corresponding to an outer circumferential surface of the outer blade arc.

In addition, any one of the inner blade and the outer blade may be inclined by 0° to 45° with respect to an outer circumferential surface or an inner circumferential surface of the other blade such that a triangular gap is formed between an outer circumferential surface of the inner blade and an inner circumferential surface of the outer blade in a state where the inner blade and the outer blade partially make contact with each other.

### Advantageous Effects

According to the present invention as described above, the following effects may be derived.

First, since the end portion of the scissors blade is provided in an annular shape, the nose hair may be safely and effectively cut, and since cutting may be performed not only through the end portions of the first and second cutting portions but also through the side portion, the present invention may be applied such that cutting may be selectively performed in an annular or straight shape according to the object. Accordingly, the technical feature may be applied not only to the nose hair but also to medical scissors or other living scissors that require such a function.

Second, since the inner blade provided in an arc shape of a semicircle has different radii based on a vertical center line and the radius of the second inner blade arc is smaller than the radius of the outer blade arc, it is possible to minimize an overlapping portion of an end of the outer blade arc corresponding to the second inner blade arc during a cutting operation, thereby preventing press-fit between two blades, and maximizing a cutting force of the scissors.

Third, when the first cutting portion and the second cutting portion cut the object by a shearing force while making contact with each other, the first cutting portion including the inner blade is pushed downward by a predetermined length due to the elastic restoring force provided by the elastic support portion, and returns to its original position, so that mobility of the first cutting portion may be secured, and due to this structure, the scissors proposed by the present invention may perform a smooth cutting operation and prevent damage to the cutting blades and a decrease in cutting force that may occur as two cutting blades overlap each other. In addition, the elastic support portion consistently pushes the inner blade upward with an elastic force, so that positions of two blades may be maintained constant when the object is cut.

Fourth, as the outer blade or the inner blade has a predetermined angle with respect to a vertical side surface, the vertical side surface of at least one of two cutting blades is provided in an oblique shape, so that it is possible to minimize the occurrence of abrasion without causing a problem of press-fit between two blades, to maintain an appropriate level of a cutting force for a long period of time, and to obtain excellent durability compared to the conventional circular scissors.

### DESCRIPTION OF DRAWINGS

FIGS. 1a and 1b are views for explaining scissors conventionally proposed by the present applicant, in which FIG. 1a is a perspective view of the conventionally proposed scissors, and FIG. 1b is a view for explaining a structure of an outer blade and an inner blade of the conventionally proposed scissors.

FIG. 2 is a perspective view of scissors according to one embodiment of the present invention.

FIG. 3 is an exploded perspective view of the scissors according to one embodiment of the present invention.

FIGS. 4a to 4c are views for explaining first and second cutting portions of the scissors according to one embodiment of the present invention.

FIGS. 5a and 5b are views for explaining shapes of an outer blade and an inner blade of the scissors according to one embodiment of the present invention.

FIG. 6 is a view for explaining an elastic support portion according to one embodiment of the present invention.

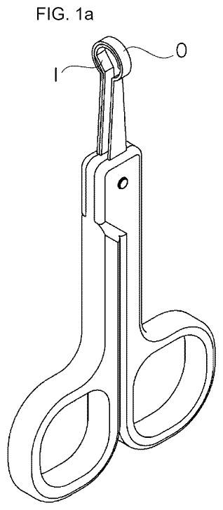

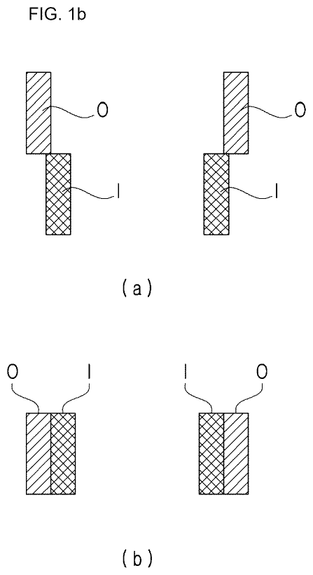

### MODE FOR INVENTION

Preferred embodiments of the present invention will be described in more detail with reference to the accompanying drawings, but the already well-known technical parts will be omitted or summarized for the brevity of description.

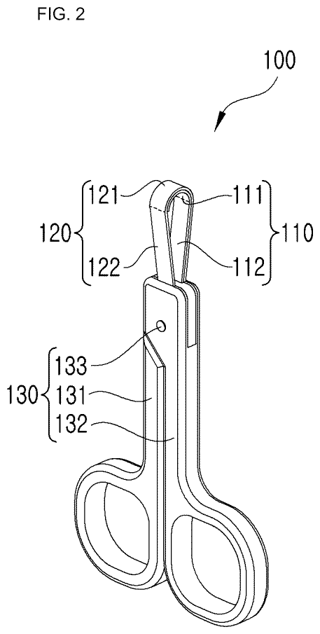

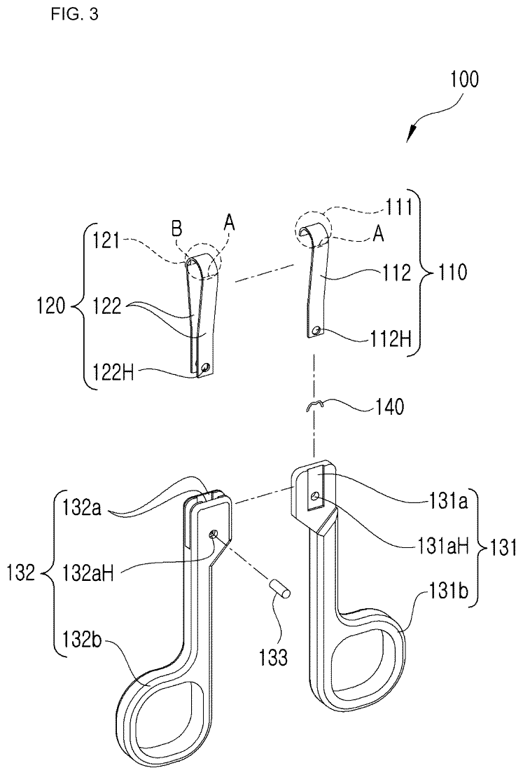

FIG. 2 is a perspective view of scissors according to one embodiment of the present invention, and FIG. 3 is an exploded perspective view of the scissors according to one embodiment of the present invention.

Referring to FIGS. 2 and 3, scissors 100 according to one embodiment of the present invention includes a first cutting portion 110, a second cutting portion 120, a body portion 130, and an elastic support portion 140.

The first cutting portion 110 is provided to cut an object, and includes an inner blade 111 that has a predetermined radius and is bent convexly upward, and a first support rack 112 that extends from one end A of the inner blade to support the inner blade 111. Any one configuration of the inner blade 111 and the first support rack 112 may be provided with a cutting surface (not shown) inclined in one direction in order to cut the object. The first support rack 112 is integrally formed with the inner blade 111.

The second cutting blade 120 cuts the object by partially making contact with one surface of the first cutting portion 110. In this case, the second cutting portion 120 includes an outer blade 121 that has a predetermined radius and is provided in a bent shape so as to be convex upward, and is disposed so as to surround the inner blade 111, and second support racks 122 that extend from both ends A and B of the outer blade 121 to support the outer blade 121. One surface of any one configuration of the inner blade 121 and the first support rack 122 may be provided with a cutting surface (not shown) inclined in one direction.

For reference, an overlapping shape of the first cutting portion 110 and the second cutting portion 120 is proposed as a shape close to a water drop shape in order to reduce the possibility of a user being injured, but the present invention is not limited thereto.

The body portion 140 includes a pair of frames 131 and 132 formed at one side thereof with coupling grooves 131a and 131b into which any one of the first and second support racks 112 and 122 is fitted, and formed at the other side thereof with gripping portions 131b and 132b, and a coupling portion 133 for hinge-coupling the pair of frames (hereinafter, referred to as a “first frame 131” and a “second frame 132”) such that the first and second cutting portions 110 and 120 make contact with each other or are separated from each other while rotating around a point within a predetermined radius.

For example, the first frame 131 may be formed separately from the first cutting portion 110 and coupled to the first support rack 112 of the first cutting portion 110, and the second frame 132 may be formed separately from the second cutting portion 120 and coupled to the second support rack 122 of the second cutting portion 120. In this case, the first frame 131 may be provided with one coupling groove 131a for fitting into one first support rack 112 integrally extending from one end A of the inner blade 111, and the second frame 132 may be provided with two coupling grooves 132a for fitting into two second support racks 122 extending from both ends A and B of the outer blade 121.

For reference, as the first cutting portion 110 and the second cutting portion 120 are provided to be fitted into the first frame 131 and the second frame 132, respectively, it is possible to replace only the corresponding cutting portion when the first cutting portion 110 and the second cutting portion 120, that is, the blades of scissors, are worn.

The gripping portions 131b and 132b are formed in a ring shape into which a user's finger may be fitted, and are provided in the first frame 131 and the second frame 132, respectively. For reference, the first cutting portion 110 and the second cutting portion 120 may be formed in a direction perpendicular to the gripping portions 131b and 132b with respect to a plane of the gripping portions 131b and 132b, and may be rotated in a direction perpendicular to a movement direction of the gripping portions 131b and 132b.

The coupling portion 133 hinge-couples the first frame 131 and the second frame 132 such that the first and second cutting portions 110 and 120 may be rotated around an axis within a predetermined radius.

The elastic support portion 140 is positioned in the coupling groove so as to support at least one of the first and second support racks 112 and 122 fitted into the coupling grooves 131a and 132a, and provides an elastic restoring force to a longitudinal movement of the first or second cutting portion 110 or 120.

For example, the elastic support portion 140 may be positioned in the coupling groove 131a provided in the first frame 131 to provide the elastic restoring force to the longitudinal movement of the first cutting portion 110. When the object is cut as the first cutting portion 110 and the second cutting portion 120 partially make contact with each other, the inner blade 111 is appropriately pushed downward based on a longitudinal direction by the elastic support portion 140 and smoothly led into the inner circumferential surface side of the outer blade 121. In order to perform the cutting operation once again, even when the inner blade 111 led into the inner circumferential surface side of the outer blade 121 is separated, the inner blade 111 whose mobility in the longitudinal direction is secured by the elastic support portion 140 is moved upward by a predetermined length, and may be smoothly separated even if the user does not apply an excessive force. That is, the elastic support portion 140 prevents two blades of the scissors 100 proposed by the present invention from overlapping each other, or prevents the cutting blade from being damaged and a cutting force from being reduced due to press-fit, and maintains a predetermined level of a cutting force for a long period of time.

Hereinafter, the first cutting portion 110 and the second cutting portion 120 will be described in more detail with reference to FIGS. 3 to 5.

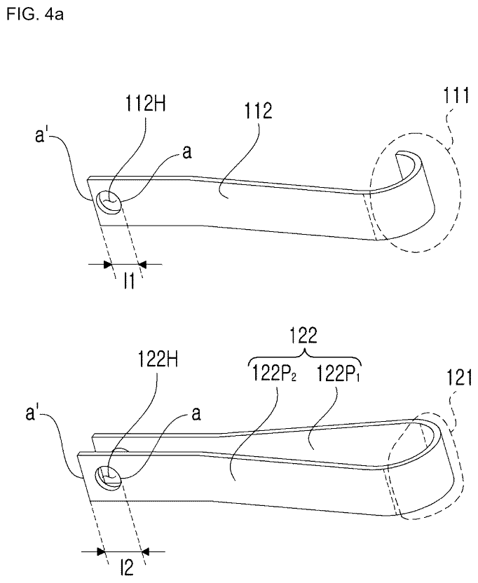

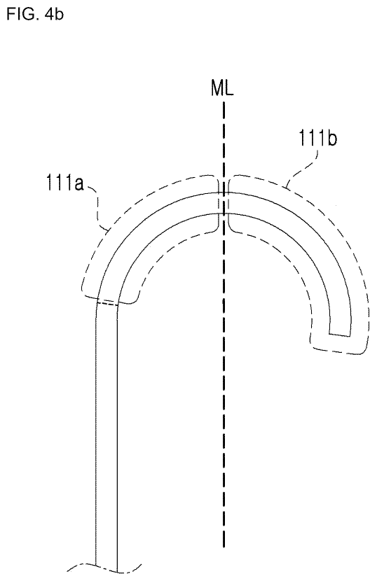

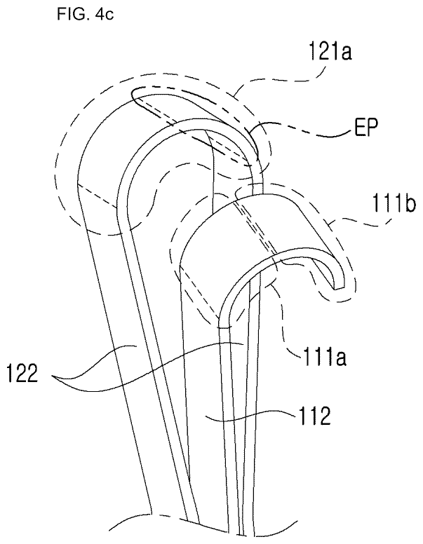

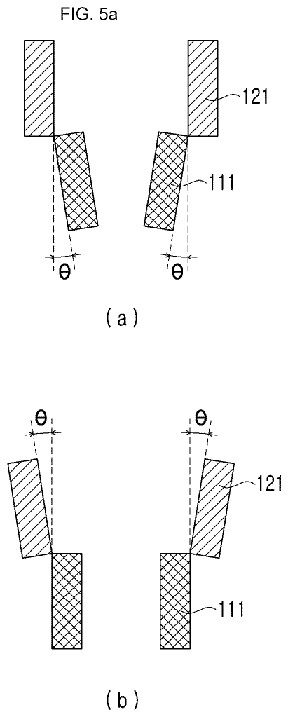

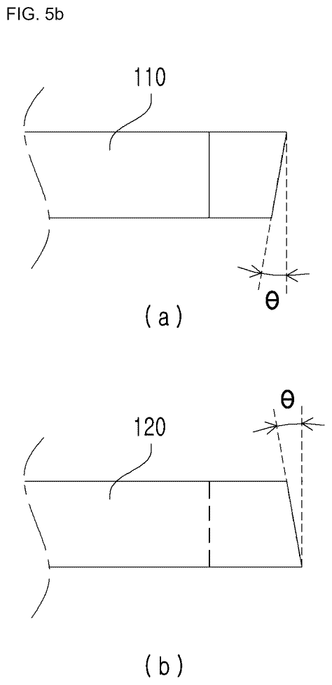

FIGS. 4a to 4c are views for explaining the first and second cutting portions of the scissors according to one embodiment of the present invention, and FIGS. 5a and 5b are views for explaining shapes of an outer blade and an inner blade of the scissors according to one embodiment of the present invention.

Referring to FIGS. 3 to 5, the first support rack 112, the second support rack 122, and the coupling grooves 131a and 132a may have coupling holes 112H, 122H, 131aH, and 132aH into which the coupling portion 133 is coupled, respectively.

As shown in FIG. 4a, a length l₁ from one end a of the coupling hole 112H formed in the first support rack to a lower end a′ of the first support rack fitted into the coupling groove 131a is shorter than a length l₂ from one end a of the coupling hole 122H formed in the second support rack to a lower end a′ of the second support rack fitted into the coupling groove.

In this case, the elastic support portion 140 is positioned in an empty space S that is defined by the lower end of the first support rack 112 and both side surfaces and a lower surface of the coupling groove 131a as a lower portion of the first support rack 112 is fitted into the coupling groove 131a such that the coupling hole 112H formed in the first support rack 112 is disposed on the same horizontal line as the coupling hole 131aH formed in the coupling groove 131a.

For reference, in order to derive the technical features of the present invention, the mobility of the first cutting portion 110 is secured in the longitudinal direction due to the elastic restoring force by the elastic support portion 140 in a state in which the position of the second cutting portion 120 is fixed, and when the first cutting portion 110 moves in the longitudinal direction, the coupling portion 133 fitted into the coupling holes 112H, 122H, 131aH, and 132aH disposed on the same horizontal line may include a lead-in groove (not shown) recessed by a predetermined depth toward a center portion of the coupling portion 133 such that a part of an edge of the coupling hole 112H of the first support rack may be partially led into the coupling portion 133.

In this case, when one side of the second frame 132, any one portion 122P₁ of two portions of the second support rack 122, the first support rack 112, the first frame 131, the other portion 122P₂ of two portions of the second support rack 122, and the coupling holes 132aH, 122H, 112H, 131aH, 122H, and 132aH formed at the other side of the second frame 132, respectively, the lead-in groove may be formed only at a position corresponding to the arrangement of the first support rack 122. The insertion groove may be provided in a polygonal shape such as a semicircle, a triangle, a square, or a rhombus.

In addition, the scissors 100 proposed by the present invention may cut the object through the inner blade 111 and the outer blade 121 (hereinafter, for convenience of description, a cut portion composed of the inner blade and the outer blade is referred to as a first cut portion), which are portions partially making contact with each other during a cutting operation, between the configurations of the first cutting portion 110 and the second cutting portion 120, and a portion 122P₂ (hereinafter, for convenience of description, a portion where cutting is performed between the first and second support racks is referred to as a second cut portion) corresponding to the first support rack 112 between two portions of the first support rack 112 and the second support rack 122.

In this case, the object may be cut in an arc shape through the first cut portion, and the object may be cut close to a straight line through the second cut portion.

A larger number of nose hair may be uniformly cut by using both the first cut portion and the second cut portion, compared to conventional nose hair cutting tools when the object, for example, nose hair is cut and also, an object requiring hook-shaped cutting may be cut.

In addition, each of the first cutting portion and the second cutting portion may be partially used so that cutting may be performed in a cutting shape selectively required according to the object. Accordingly, the scissors 100 proposed by the present invention may be applied not only for nose hair removal but also for medical and other living uses that require such a function.

As shown in FIG. 4b, the inner blade 111 may be formed in an arc shape and bent convexly upward, in which a first inner blade arc 111a, which is positioned, on the basis of a highest point, between one end A making contact with the first support rack and the highest point, may have a radius different from a second inner blade arc 111b positioned between the highest point and the other end B.

In this case, the radius of the first inner blade arc 111a is preferably larger than the radius of the second inner blade arc 111b. For example, when the radius of the first inner blade arc 111a is provided to be 3 to 5 mm, the second inner blade arc 111b may be provided to have a radius of less than 3 mm.

In addition, the radius of the second inner blade arc 111b may be smaller than the radius of the outer blade arc 121a positioned between both ends A and B of the outer blade 121 making contact with the second support rack 122.

More specifically, an outer radius, which is a radius corresponding to an outer circumferential surface of the second inner blade arc 111b, may be greater than an inner radius, which is a radius corresponding to an inner circumferential surface of the outer blade arc 121a, and may be less than the outer radius of the outer blade arc 121a, and the inner radius of the second inner blade arc 111b may be less than both the inner radius and the outer radius of the outer blade arc 121a.

Referring to FIGS. 4b to 4c, as the inner blade 111 provided in the above-described structure, that is, the arc shape of the semicircle, is provided to have different radii based on the highest point positioned at a portion where a vertical center line ML is shown, and the radius of the second inner blade arc 111b is smaller than the radius of the outer blade arc 121a, the overlapping portion between an end EP of the outer blade 121 corresponding to the second inner blade arc 111b during the cutting operation is minimized, press-fit between two blades may be prevented, and the cutting force of the scissors 100 may be maximized.

Referring to FIGS. 5a and 5b, as for shapes of the inner blade 111 and the outer blade 121, any one of the inner blade 111 and the outer blade 121 may be inclined by 0° to 45° with respect to an outer circumferential surface or an inner circumferential surface of the other blade such that a triangular gap is formed between an outer circumferential surface of the inner blade 111 and an inner circumferential surface of the outer blade 121 in a state where the inner blade 111 and the outer blade 121 partially make contact with each other.

First, FIG. 5a(a) and 5b(a) show a case where the vertical side surface of the inner blade 111 is inclined at a predetermined angle with respect to the inner circumferential surface of the outer blade 121. More specifically, FIG. 5a(a) shows a cross-sectional shape perpendicular to the longitudinal direction in a state where one side surface of the first cutting portion 110 is positioned at a lower side, the inner blade 111 of the first cutting portion 110 and the outer blade 121 of the second cutting portion 120 partially make contact with each other, one side surface of the second cutting portion 120 is adjacent to the other side surface of the inner blade 120, and the other side surface of the second cutting portion 120 is positioned at an upper side. FIG. 5b(a) shows the first cutting portion 110 when viewed from a side.

Next, FIG. 5a(b) and 5b(b) show a case where the vertical side surface of the outer blade 121 is inclined outward at a predetermined angle with respect to the outer circumferential surface of the inner blade 111. More specifically, FIG. 5b(b) shows a cross-sectional shape perpendicular to the longitudinal direction in a state where one side surface of the first cutting portion 110 is positioned at a lower side, the inner blade 111 of the first cutting portion 110 and the outer blade 121 of the second cutting portion 120 partially make contact with each other, one side surface of the second cutting portion 120 is adjacent to the other side surface of the inner blade 120, and the other side surface of the second cutting portion 120 is positioned at an upper side. FIG. 5b(b) shows the second cutting portion 120 when viewed from a side.

In this case, from the structures proposed in FIGS. 5(a) to 5(b), as the first cutting portion 110 or the second cutting portion 120 has a predetermined angle with respect to the vertical side surface of the other cutting portion and the vertical side surface of at least one of two scissors blades is provided in an oblique shape, the scissors 100 according to one embodiment of the present invention may minimize the occurrence of abrasion without press-fit between two blades, maintain an appropriate level of a cutting force for a long period of time, and have excellent durability compared to the conventional circular scissors.

In addition, when the inner blade 111 is to be removed from the inside of the outer blade 121 after the cutting operation, it is possible to provide a smooth feeling of use even if the user does not apply an excessive force.

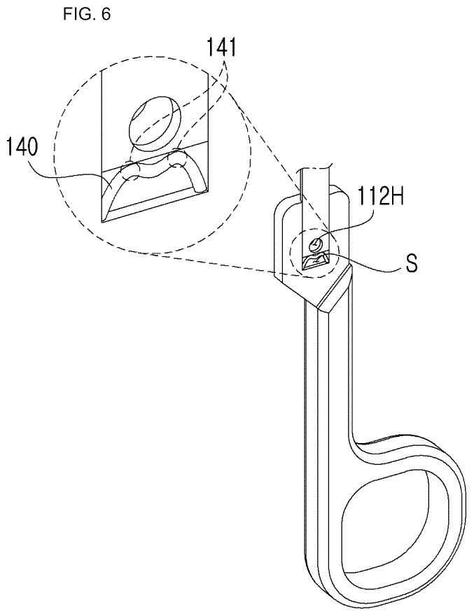

Hereinafter, the elastic support portion 140 will be described in more detail with reference to FIG. 6. In this case, FIG. 6 is a view for explaining the elastic support portion according to one embodiment of the present invention.

Referring to FIG. 6, the elastic support portion 140 is positioned in the empty space S generated between the lower end of the first support rack 112 and the coupling groove 131a when the first support rack 112 is fitted into the coupling groove 131a. In this case, both end portions of the elastic support portion 140 may be disposed to face and make contact with an end portion of the coupling groove 131a or the lower end of the first support rack 112.

For example, when both end portions of the elastic support portion 140 are disposed to face and make contact with the end portion of the coupling groove 131a, at least one or more convex portions 141 that are convexly bent upward toward the lower end of the first support rack 112 are provided, so that the convex portions 141 are disposed to face and make contact with the lower end of the first support rack 112.

As another example, when both end portions of the elastic support portion 140 are disposed to face and make contact with the lower end of the first support rack 112, at least one or more concave portions (not shown) that are concavely bent downward are provided, so that the concave portions are disposed to face and make contact with the end portion of the coupling groove 131a.

As a result, when the object is cut by a shearing force as the inner blade 111 and the outer blade 112 make contact with each other, the first cutting portion 110 including the inner blade 111 is pushed downward by a predetermined length due to the elastic restoring force provided by the elastic support portion 140, and returns to its original position, thereby securing the mobility of the first cutting portion 110.

In addition, the elastic support portion 140 may constantly push the inner blade 111 upward with an elastic force, thereby constantly maintaining the positions of two scissors blades when the object is cut. Accordingly, the elastic support portion 140 may reduce an error between the scissors blades, which may occur from a tolerance caused during manufacturing of a product, thereby improving cutting precision.

Accordingly, the scissors 100 proposed by the present disclosure may smoothly perform a cutting operation when the object is cut, and may prevent damage and a decrease in cutting force that may occur as two blades overlap each other.

For reference, the elastic support portion 140 may be provided as a wire spring manufactured by processing a metal wire. In this case, a shape of the elastic support portion 140 may be formed in an “M” shape, a “∩” shape, a “W” shape, a “U” shape, or the like, but the present invention is not limited thereto, and any shape may be applied as long as it includes at least one convex portion 141 or concave portion that makes contact with the lower end of the first support rack 112 or the end portion of the coupling groove 131a and may provide an elastic restoring force in the longitudinal direction between the convex portion 141 or the concave portion and both end portions.

In addition, according to the embodiment, the elastic support portion 140 may be implemented to support only the first support rack 112, support only the second support rack 122, or support both the first support rack 112 and the second support rack 122, and obviously, the support rack of which the lower end makes contact with the elastic support portion 140 may be adjusted in length from one end of the coupling hole formed in the support rack to the lower end of the corresponding support rack fitted into the coupling groove provided in at least one of the first frame and the second frame such that a lower surface of the coupling groove 131a and a lower end of the corresponding support rack are spaced apart from each other by a predetermined interval.

As described above, the detailed description of the present invention has been made by the embodiments with reference to the accompanying drawings, but the above-described embodiments are merely described as preferred examples of the present invention, and thus the present invention should not be construed as being limited to the above embodiments, and the scope of the present invention should be understood as the following claims and equivalents thereof.

1. Scissors comprising:
a first cutting portion having an inner blade that has a predetermined radius and is bent convexly upward, and a first support rack that extends from one end of the inner blade to support the inner blade;
a second cutting portion having an outer blade that has a predetermined radius and is provided in a bent shape so as to be convex upward, and is disposed so as to surround the inner blade, and second support racks that extend from both ends of the outer blade to support the outer blade;
a body portion including a pair of frames formed at one side thereof with coupling grooves into which any one of the first and second support racks is fitted, and formed at the other side thereof with gripping portions, and a coupling portion for hinge-coupling the pair of frames such that the first and second cutting portions make contact with each other or are separated from each other while rotating around a point within a predetermined radius; and
an elastic support portion positioned in the coupling groove so as to support at least one of the first and second support racks fitted into the coupling grooves, and configured to provide an elastic restoring force to a longitudinal movement of the first or second cutting portion.

2. The scissors of claim 1, wherein the first support rack, the second support rack, and the coupling grooves have coupling holes into which the coupling portion is coupled, and
a length from one end of the coupling hole formed in the first support rack to a lower end of the first support rack coupled to the coupling groove is shorter than a length from one end of the coupling hole formed in the second support rack to a lower end of the second support rack coupled to the coupling groove.

3. The scissors of claim 2, wherein the elastic support portion is positioned in an empty space that is defined by the lower end of the first support rack and both side surfaces and a lower surface of the coupling groove as a lower portion of the first support rack is fitted into the coupling groove such that the coupling hole formed in the first support rack is disposed on the same horizontal line as the coupling hole formed in the coupling groove.

4. The scissors of claim 1, wherein the inner blade is formed in an arc shape and bent convexly upward, in which a first inner blade arc, which is positioned, on a basis of a highest point, between one end making contact with the first support rack and the highest point, has a radius different from a second inner blade arc positioned between the highest point and the other end.

5. The scissors of claim 4, wherein a radius corresponding to an outer circumferential surface of the second inner blade arc is larger than a radius corresponding to an inner circumferential surface of an outer blade arc, and is smaller than a radius corresponding to an outer circumferential surface of the outer blade arc.

6. The scissors of claim 1, wherein any one of the inner blade and the outer blade is inclined by 0° to 45° with respect to an outer circumferential surface or an inner circumferential surface of the other blade such that a triangular gap is formed between an outer circumferential surface of the inner blade and an inner circumferential surface of the outer blade in a state where the inner blade and the outer blade partially make contact with each other.
